(19) United States
(12) Patent Application Publication
(10) Pub. No.: US 2008/0298201 A1
(43) Pub. Date: Dec. 4, 2008

(54) METHOD AND PROGRAM FOR OBTAINING AND SETTING OF RECORDING SETTING INFORMATION, AND DATA RECORDING/PLAYBACK DEVICE

(75) Inventor: Hiroya Kakimoto, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/128,029

(22) Filed: May 28, 2008

(30) Foreign Application Priority Data
May 29, 2007 (JP) 2007-141215
May 29, 2007 (JP) 2007-141216

(51) Int. Cl. G11B 3/64

(52) U.S. Cl. 369/84

(57) ABSTRACT

A method for obtaining and setting recording setting information, including: obtaining device identification information of an optical disc recording/playback device; transmitting a recording setting information request signal including at least the device identification information to a server connected through a network; receiving recording setting information corresponding to at least the device identification information transmitted from the server based on the recording setting information request signal; and storing the received recording setting information in memory within the optical disc recording/playback device. Thus, for example, recording setting information as to all of optical discs may be obtained and set as much as possible in a case wherein access to the server can be performed, whereby even a case can be handled wherein data recording is carried out as to various types of optical discs later.

### BACKGROUND OF THE INVENTION

1. Field of the Invention

The present invention relates to a technique for obtaining and setting recording setting information employed for data recording as to an optical disc.

2. Description of the Related Art

For example, with Japanese Unexamined Patent Application Publication No. 2003-228836, a technique has been disclosed wherein information for specifying a write strategy of an optical recording medium in which data can be written is obtained externally, and data is written in the optical recording medium in accordance with the write strategy specified with the obtained relevant information.

Also, with Japanese Unexamined Patent Application. Publication No. 2005-122840, a technique has been disclosed whereby playback or recording of information can be performed according to the features of an individual recording medium. Specifically, an information processing device obtains a unique ID from a mini disc including an individual information recording area. The property information of an individual mini disc is managed by a network server. The information processing device obtains the property information corresponding to the mini disc specified with the unique ID from the network server, optimizes the servo properties according to the property information, and performs recording or playback of information.

### SUMMARY OF THE INVENTION

As for optical disc recording setting information such as a write strategy, there is a need to include not only information corresponding to optical disc information, e.g., media ID but also information corresponding to the device type of an optical disc recording/playback device. This is because there are differences such as components, circuit design, and so forth employed for each device type of an optical disc recording/playback device, and accordingly, recording setting information most suitable for the device type is needed. Therefore, an optical disc recording/playback device stores recording setting information corresponding to not only the media ID of an optical disc but also the device type beforehand. Note however, with regard to optical discs sold after a user has purchased the device type, the recording setting information thereof is not stored in the device type of optical disc recording/playback device, and accordingly, there is a need to obtain new information corresponding to the device type of optical disc recording/playback device again.

With the above-mentioned existing techniques, only a simple arrangement has been disclosed wherein data regarding an optical disc is obtained externally, but no arrangement has been made wherein data suitable for a combination between an optical disc recording/playback device and optical disc is obtained. Also, a problem in the case of obtaining data through a network has not been taken into consideration so much.

Accordingly, it is an object of the present invention to provide a technique for obtaining recording setting information necessary for subjecting an optical disc to data recording more appropriately to perform setting and recording based on the information thereof.

Also, it is an object of the present invention to provide a technique for obtaining suitable recording setting information according to the use situation of an optical disc, network environment, and so forth in an optical disc recording/playback device to perform setting and recording based on the information thereof.

Further, it is an object of the present invention to provide a technique for obtaining recording setting information necessary for subjecting an optical disc to data recording effectively to perform setting and recording.

According to a first aspect of the present invention, a method for obtaining and setting recording setting information includes: obtaining device identification information of an optical disc recording/playback device; transmitting a recording setting information request signal including at least the device identification information to a server connected through a network; receiving recording setting information corresponding to at least the device identification information transmitted from the server based on the recording setting information request signal; and storing the received recording setting information in memory within the optical disc recording/playback device. Thus, recording setting information suitable for the device type of an optical disc recording/playback device can be obtained and set. For example, in a case wherein a server can be accessed, recording setting information as to all types of optical disc may be obtained and set as much as possible, thereby enabling even a case wherein various types of optical disc are subjected to data recording later to be handled regardless of whether to connect to a network at that time.

Also, the method may further include: obtaining a media ID read out from an optical disc set in the optical disc recording/playback device as an acquisition media ID; and obtaining at least one media ID as a registered media ID from a media ID administration unit storing media IDs of optical discs having a type subjected to data recording at the optical disc recording/playback device in the past. In this case, the above-mentioned recording setting information request signal further includes the acquisition media ID and the registered media ID. Also, the recording setting information received corresponds to the media IDs included in the acquisition media ID and the registered media ID, and the device identification information. Thus, even in an environment wherein a network cannot be used at the time of data recording, when a server can be accessed, recording setting information for data recording as to an optical disc subjected to data recording this time, and an optical disc used in the past can be obtained and set effectively.

Further, the method may further include obtaining a media ID read out from an optical disc set in the optical disc recording/playback device as an acquisition media ID. In this case, the above-mentioned recording setting information request signal may further include the acquisition media ID. Also, the recording setting information received may correspond to the acquisition media ID and the device identification information. Thus, data necessary for data recording this time can be obtained and set effectively.

Also, the method may further include: obtaining a media ID read out from an optical disc set in the optical disc recording/playback device as an acquisition media ID; and obtaining recording rate information of data recording carried out at the optical disc recording/playback device. In this case, the above-mentioned recording setting information request signal may further include the acquisition media ID, and the recording rate information. Also, the recording setting information received may correspond to the acquisition media ID, the recording rate information, and the device identification information. Thus, data necessary for data recording this time can be obtained and set effectively.

Now, the method may further comprise obtaining an address of a server serving as a transmission destination this time from an address administration unit holding the transmission destination server address of the recording setting information request signal for each media ID. In this case, the above-mentioned transmission step includes transmitting the recording setting information request signal to the obtained address. For example, a case wherein a server is installed for each optical disc supply source can be handled. However, a server may access, for example, a server installed by a writing program vender of optical discs.

According to another aspect of the present invention, a recording setting information setting method includes: obtaining device identification information of an optical disc recording/playback device; transmitting an update setting item request signal including at least data representing a last access date-and-time to a first server; a first receiving of recording setting information items updated at the last access date and time and thereafter, transmitted from the first server based on the update setting item request signal; transmitting a recording setting information request signal including at least the updated items of the recording setting information items received in the first receiving, and the device identification information to a second server; a second receiving of the recording setting information corresponding to the device identification information transmitted from the second server based on the recording setting information request signal; and storing the recording setting information received in the second receiving in memory within the optical disc recording/playback device.

According to such an arrangement, of the recording setting information items, at least only the updated items can be downloaded from the second server, whereby recording setting information necessary from now on can be obtained and set effectively.

Also, in the above-mentioned first receiving, an address and data of the second server may be received together with the recording setting information items. Thus, an arrangement may be made wherein, for example, URLs are managed at the first server together so as to be informed to the terminal side, or the address and data of the second server are managed at the terminal side. Note that the first server is identical to the second server in some cases.

Further, the above-mentioned recording setting information items may be identified with at least one combination of a combination between a media ID, and media ID and strategy parameters, and a combination between a media ID, strategy parameter, and recording rate. Thus, management can be carried out with various embodiments.

Also, the above-mentioned obtaining a registered media ID may include extracting the media ID of an optical disc of which a frequency of use is a predetermined level or more from a media ID management unit as a registered media ID. Thus, recording setting information can be obtained effectively. Note that an arrangement may be made wherein of the recording setting information, all are not stored in memory within an optical disc recording/playback device, and some not immediately employed is stored in a storage device such as a personal computer or the like.

Note that a program for causing a computer to execute a recording setting information setting method according to an embodiment of the present invention can be created, and the program is stored in, for example, a storage medium such as a flexible disk, optical disc such as CD-ROM, magneto-optical disc, semiconductor memory, hard disk, or the like, or a storage device. Also, the program is distributed with a digital signal through a network in some cases. Note that data in the middle of processing is temporarily stored in a storage device such as memory or the like.

According to the present invention, recording setting information necessary for subjecting an optical disc to data recording more can be obtained and set more appropriately.

Also, according to another aspect of the present invention, suitable recording setting information can be obtained according to the use state of an optical disc, network environment, or the like in an optical disc recording/playback device.

Further, according to another aspect of the present invention, recording setting information necessary for subjecting an optical disc to data recording can be obtained and set effectively.

### BRIEF DESCRIPTION OF THE DRAWINGS

FIG. 1 is a function block diagram according to a first embodiment of the present invention.

FIG. 2 is a diagram illustrating the data structure of a strategy data storing unit.

FIG. 3 is a diagram for describing parameters in a multi-pulse format.

FIG. 4 is a diagram for describing parameters in a non-multi-pulse format.

FIG. 5 is a diagram illustrating a strategy data holding method regarding a parameter called dTtop.

FIG. 6 is a diagram illustrating an example of data stored in a URL management file.

FIG. 7 is a diagram illustrating a processing flow according to the first embodiment of the present invention.

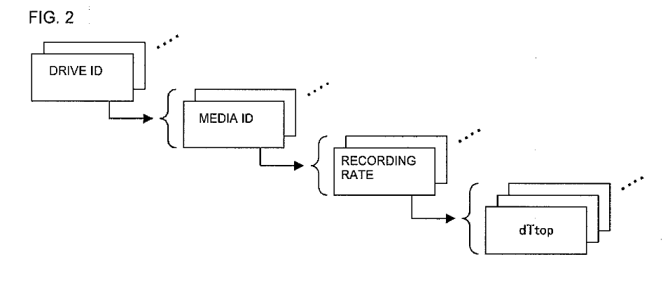

FIG. 2 is a diagram illustrating a processing flow according to the first embodiment of the present invention.

FIG. 9 is a diagram illustrating a processing flow according to the first embodiment of the present invention.

FIG. 10 is a function block diagram according to a second embodiment of the present invention.

FIG. 11 is a diagram illustrating an example of data stored in an optical disc use history file.

FIG. 12 is a diagram illustrating a processing flow according to the second embodiment of the present invention.

FIG. 13 is a diagram illustrating a processing flow according to the second embodiment of the present invention.

FIG. 14 is a diagram illustrating a processing flow according to a third embodiment of the present invention.

FIG. 15 is a diagram illustrating a processing flow according to the third embodiment of the present invention.

FIG. 16 is a diagram illustrating a processing flow according to a fourth embodiment of the present invention.

FIG. 17 is a diagram illustrating a processing flow according to the fourth embodiment of the present invention.

FIG. 18 is a function block diagram according to a fifth embodiment of the present invention.

FIG. 19 is a diagram illustrating an example of data stored in an administration table storing unit.

FIG. 20 is a diagram illustrating an example of data stored in an access history management file.

FIG. 21 is a diagram illustrating a processing flow according to the fifth embodiment of the present invention.

FIG. 22 is a diagram illustrating a processing flow according to the fifth embodiment of the present invention.

FIG. 23 is a diagram illustrating an example of data stored in an administration table storing unit according to a modification of the fifth embodiment of the present invention.

FIG. 24 is a function block diagram of a computer.

### DESCRIPTION OF THE PREFERRED EMBODIMENTS

### First Embodiment

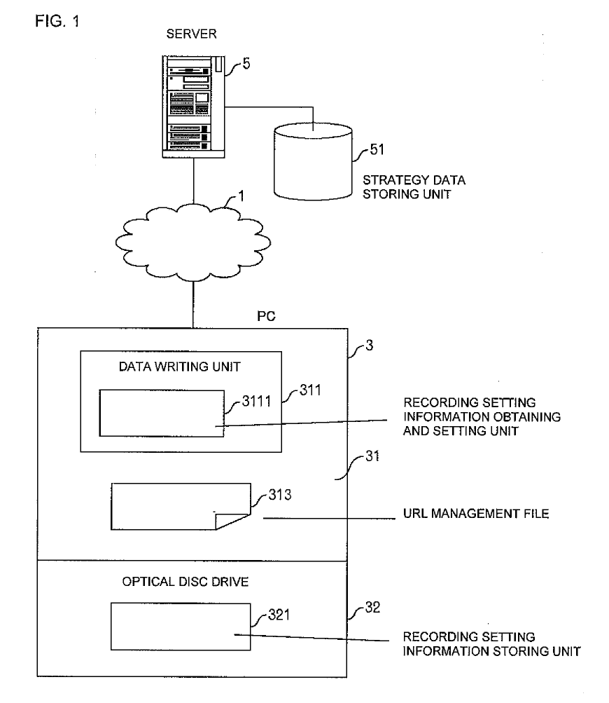

FIG. 1 illustrates a system schematic diagram according to a first embodiment. A network 1 which is, for example, the Internet, is connected with a single or multiple personal computers 3 (hereafter, abbreviated as PC) serving as a data recording/playback device, and a single or multiple servers 5 for managing a strategy data storing unit 51 for storing various types of recording setting information, i.e., strategy data. A PC 3 may be a desktop type, or may be a notebook type. The PC 3 includes a PC main unit 31, and an optical disc drive 32 which is an optical disc recording/playback device. The optical disc drive 32 may be integral with the PC main unit 31, or may be externally connected, for example by a universal serial bus (hereafter, abbreviated as USB). Also, the PC 3 may be connected to the network 1 all the time, or may be connected to the network 1 temporarily as necessary.

The PC main unit 31 includes a data writing unit 311 and a uniform resource locator (hereafter, abbreviated as URL) management file 313. The data writing unit 311 is realized by the PC main unit 31 executing a data write program according to the present embodiment. Also, the data writing unit 311 includes a recording setting information obtaining and setting unit 3111.

The optical disc drive 32 includes not only principal functions, such as a data recording function, data playback function, and so forth, but also a recording setting information storing unit 321 for storing recording setting information employed for the data recording function.

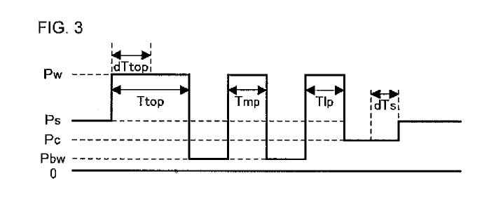

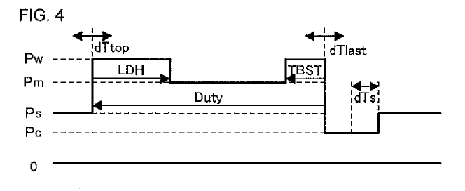

FIG. 2 schematically illustrates the management state of strategy data stored in the strategy data storing unit 51 managed by the server 5. The strategy data includes multiple parameters (only dTtop indicating a leading pulse start position is illustrated in the example shown in FIG. 2) necessary for each combination between a drive ID, media ID, and recording rate. The parameters are parameters in either a multi-pulse format such as shown in FIG. 3 or a non-multi-pulse format such as shown in FIG. 4. For example, the multi-pulse format is employed when a recording rate is low, and the non-multi-pulse format is employed when a recording rate is high, or the non-multi-pulse format is employed regarding all the recording rates. In the case of the multi-pulse format, as shown in FIG. 3, dTtop, Ttop indicating the width of a leading pulse, Tmp indicating the width of an intermediate pulse, Tlp indicating the width of a final pulse, dTs indicating the end position of a cooling pulse, and so forth, may be included in the strategy data. Similarly, in the case of the non-multi-pulse format, dTtop indicating a leading pulse start position, LDH indicating the width of a leading pulse, TBST indicating the width of a final pulse, dTlast indicating a final pulse end position, dTs indicating a cooling pulse end position, Duty indicating a pulse width equivalent to a mark creation length, and so forth, may be included in the strategy data.

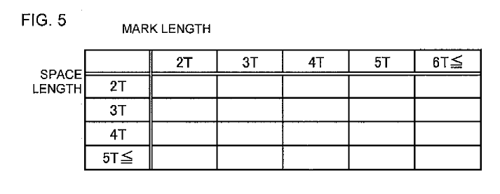

Further, as shown in FIG. 5, it is desirable to hold the setting value by a combination between a mark length to be recorded and a preceding space length regarding each parameter (only a part of the parameters in some cases). FIG. 5 illustrates a table for the case of dTtop, with regard to each of marks 2T through 6T, a setting value will be registered for each of preceding space lengths 2T through 5T. Note that with regard to a code length, a necessary code length is selected in accordance with optical disc standard.

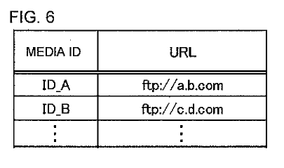

Also, FIG. 6 illustrates an example of data stored in the URL management file 313. With the example shown in FIG. 6, the URL of the server 5 is registered for each media ID. However, in a case wherein the only one server 5 is prepared for the network 1, only the URL of the server 5 is registered. Note that, for example, a server is prepared for each optical disc manufacturing maker in some cases.

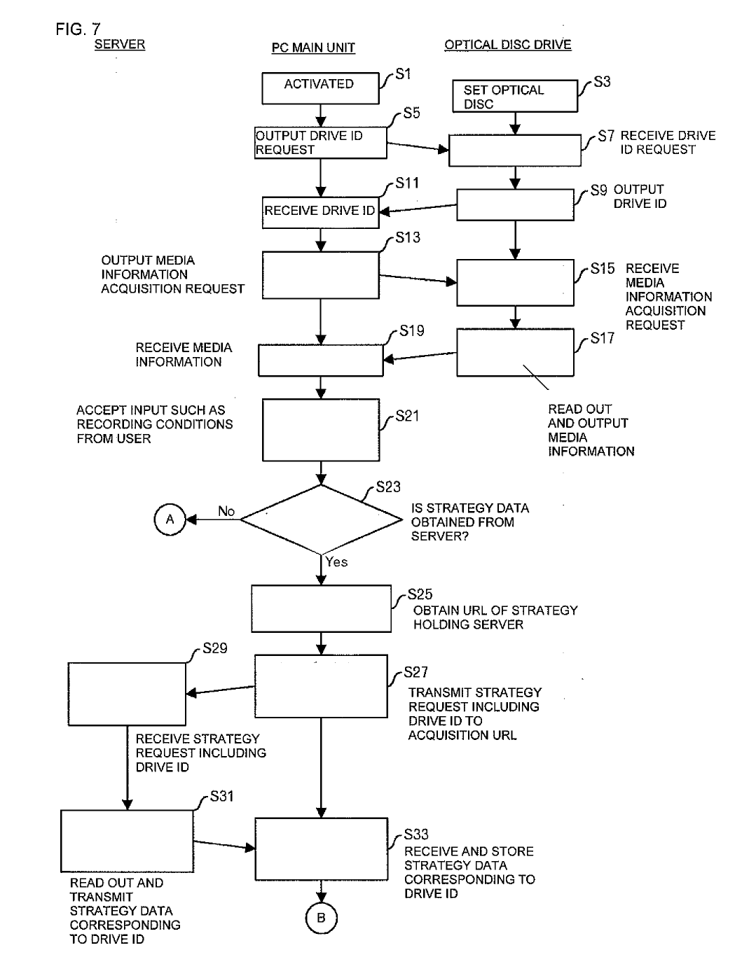

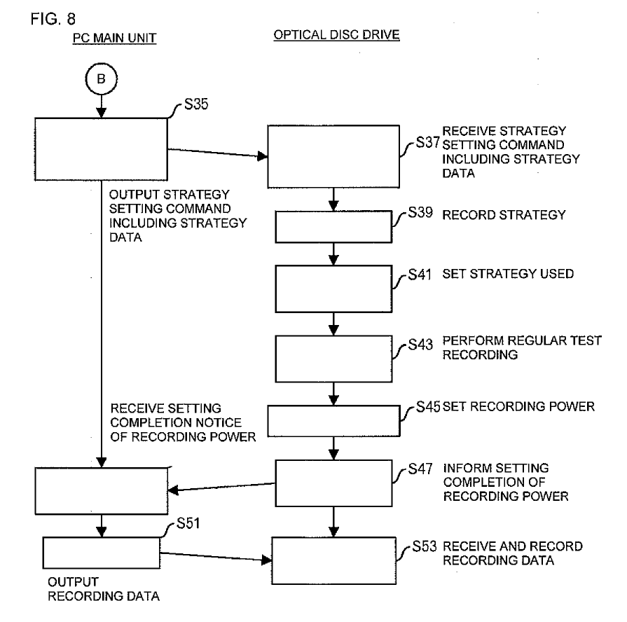

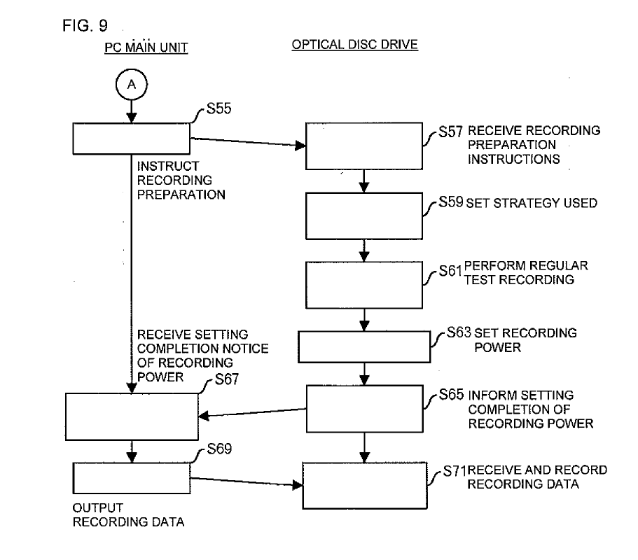

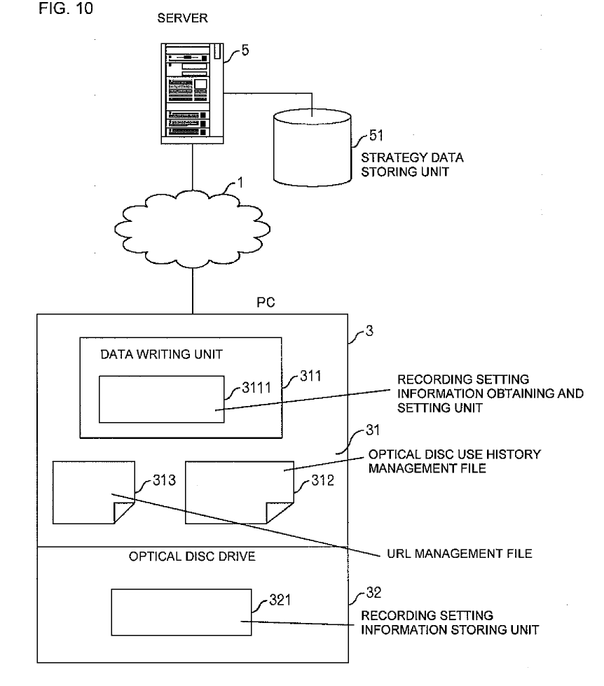

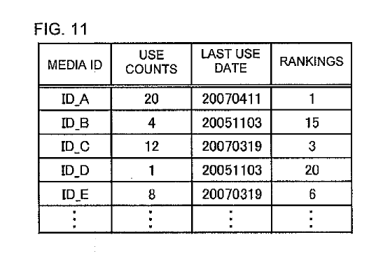

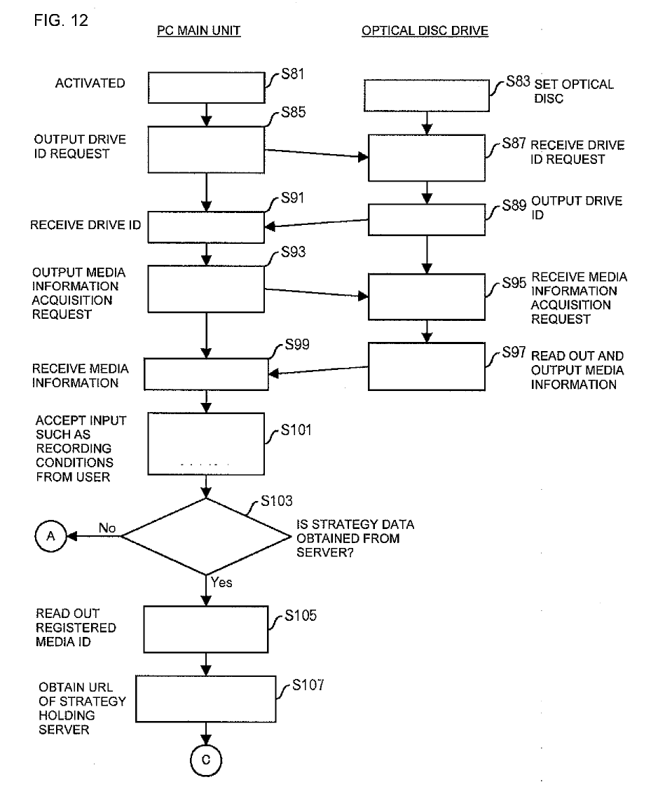

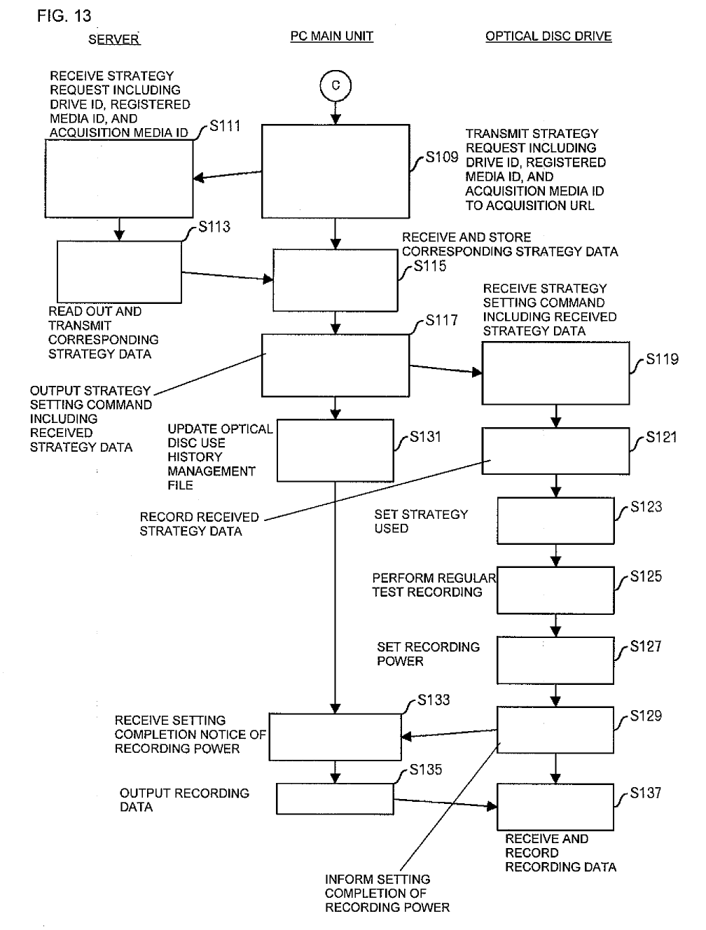

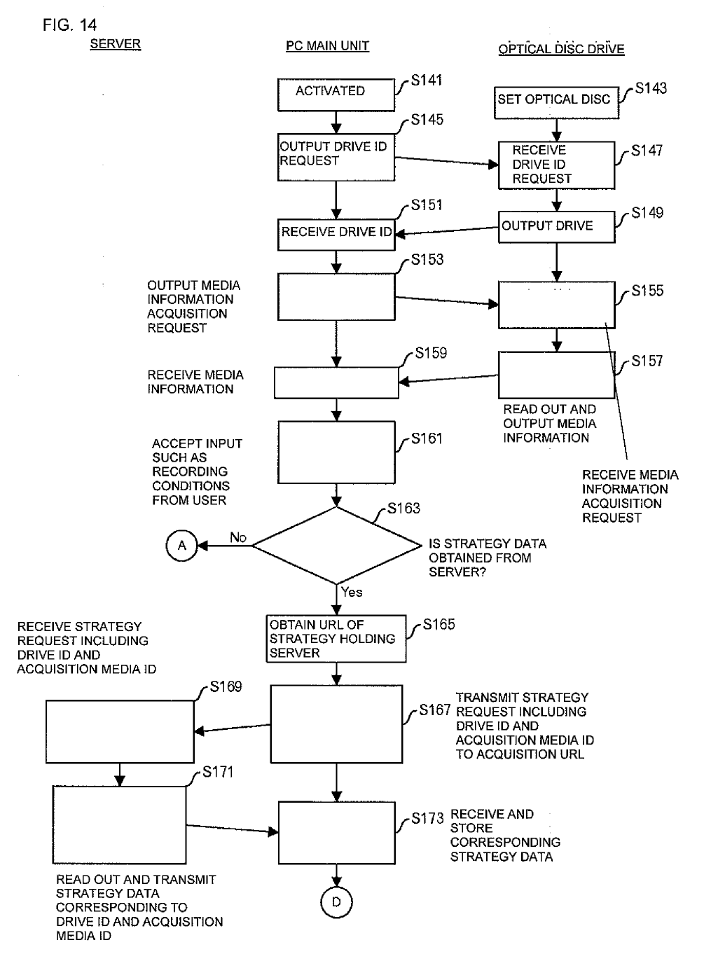

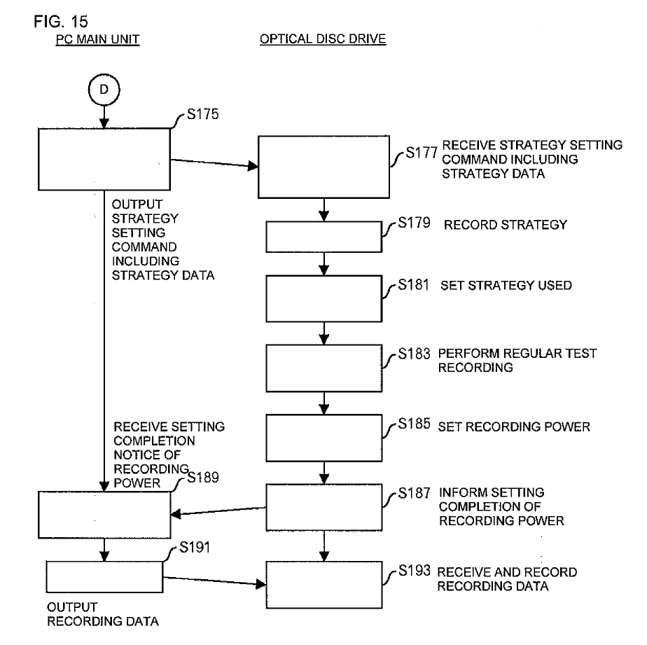

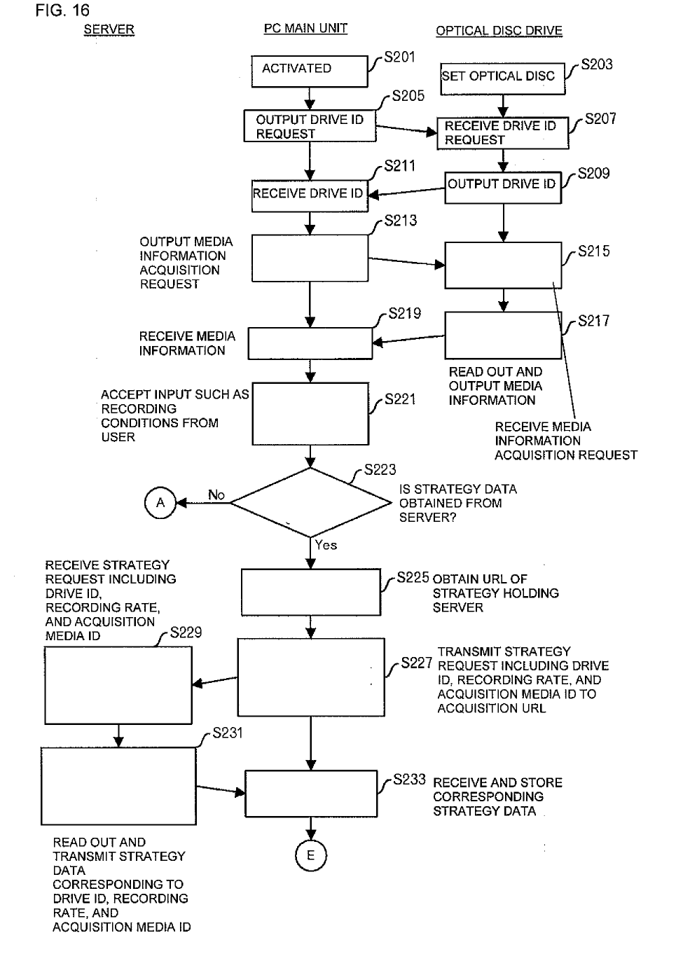

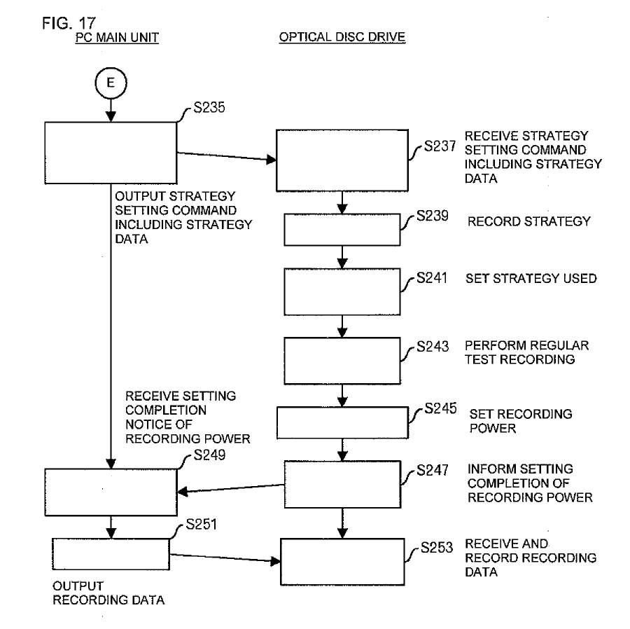

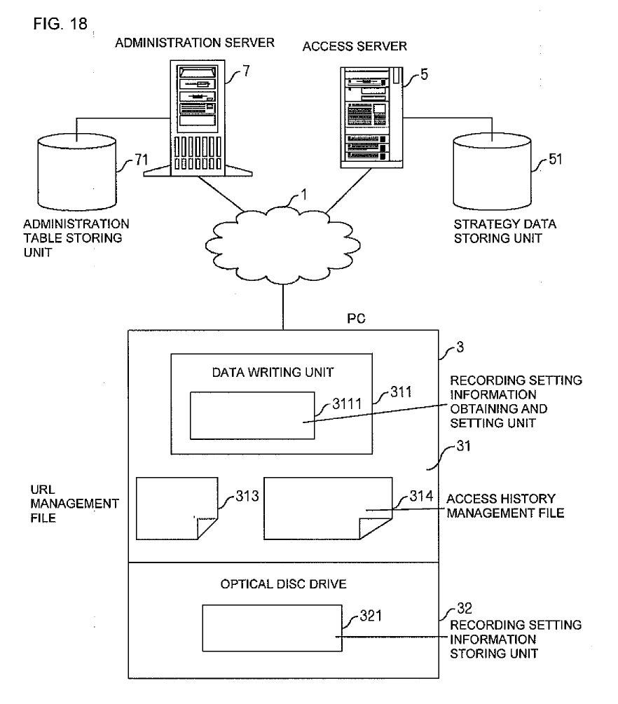

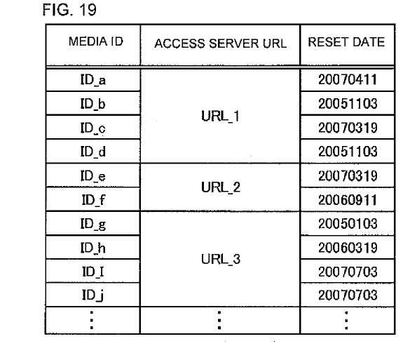

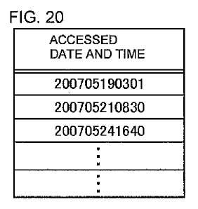

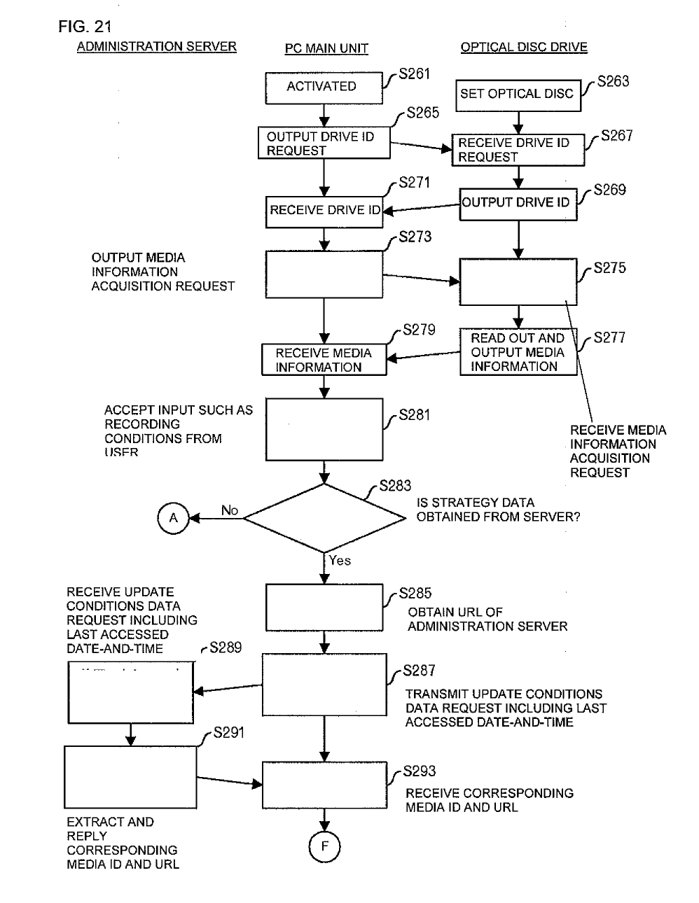

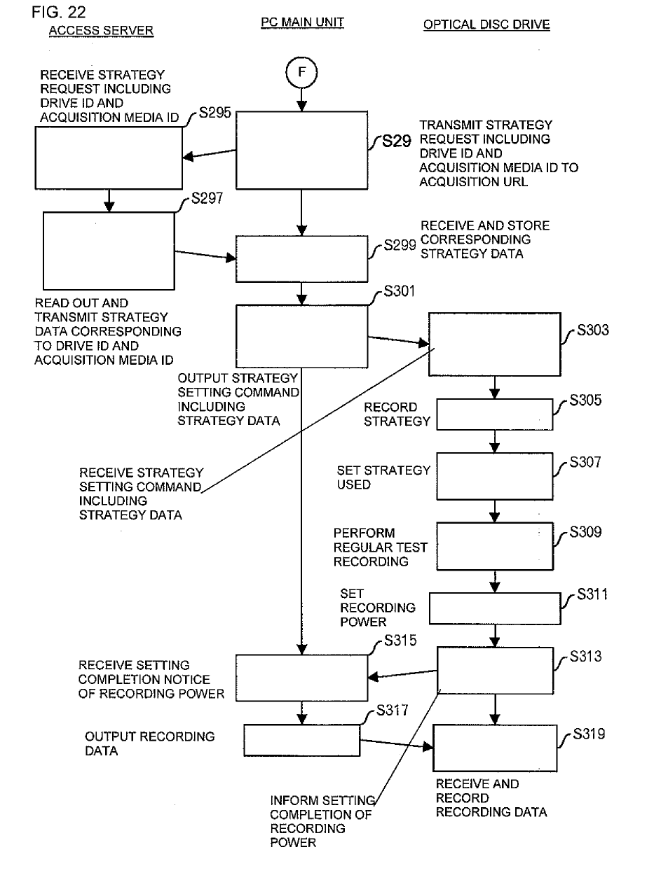

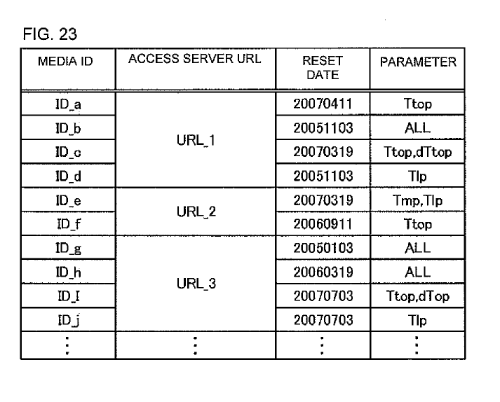

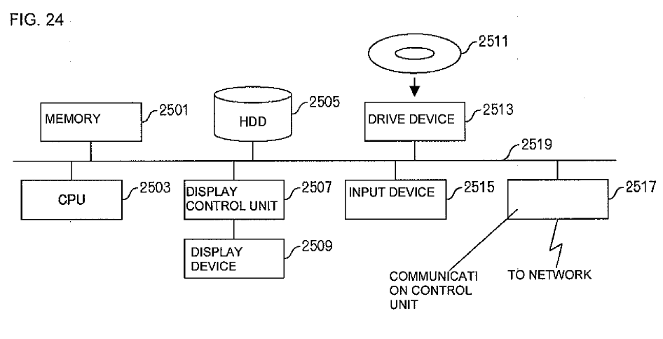

Next, the operation of the system shown in FIG. 1 will be described with reference to FIG. 7 through FIG. 9. First, for example, in response to instructions of the user of the PC 3, the data writing unit 311 is activated (step S1). Also, the user inserts an optical disc to be subjected to data recording this time into the optical disc drive 32, whereby the optical disc drive 32 sets the optical disc to a spindle motor and so forth (step S3).

Subsequently, for example, in order to obtain a drive ID (device ID) as device identification information, the data writing unit 311 of the PC main unit 31 outputs a drive ID request signal to the optical disc drive 32 (step S5). On the other hand, the optical disc drive 32 receives the drive ID request signal from the data writing unit 311 (step 57), and, for example, reads out the drive ID stored in a memory of the optical disc drive 32 to output this to the data writing unit 311 (step S9). The data writing unit 311 receives the drive ID from the optical disc drive 32, and, for example, stores this in the main memory (step S11). Note that, in a case wherein there has already been drive data obtained, such as by an OS (Operating System) or the like as the configuration data of the PC 3, the data writing unit 311 may employ the data instead of executing steps S5 through S11.

Further, the data writing unit 311 outputs a media information acquisition request signal to the optical disc drive 32 (step S13). The optical disc drive 32 receives the media information acquisition request signal (step S15), reads out media information such as a media ID and so forth from the optical disc set in step S3, and outputs this to the data writing unit 311 (step S17). The data writing unit 311 receives the media information from the optical disc drive 32, and, for example, stores this in the memory (step S19). The media information sometimes includes dedicated codes representing that processing such as obtaining strategy data from the server 5 is carried out. Further, with the present embodiment, though not employed directly, in order to record the use history of an optical disc, a media ID may be registered in a use history management file, for example.

Also, the data writing unit 311 may prompt the user to input recording conditions and so forth (recording rate, instructions regarding whether to execute processing such as obtaining strategy data from the server 5 (including settings such as execution, non-execution, automatic execution, etc.), etc.), and accept input of the recording conditions and so forth from the user (step S21).

Subsequently, the data writing unit 311 determines whether to obtain strategy data from the server 5 (step S23). For example, in the case of being instructed by the user in step S21, in the case of dedicated codes such as described in step S19 being received, in the case of confirming that the PC 3 is connected to the network 1, or the like, determination is made that strategy data is obtained from the server 5. In other cases, the processing proceeds to the processing shown in FIG. 9 through a terminal A.

In the case of obtaining strategy data from the server 5, the recording setting information obtaining and setting unit 3111 of the data writing unit 311 reads out the URL of the server 5 holding strategy data, for example, from the URL management file 313 (step S25). Note that the URL of the server 5 is managed by the PC main unit 31 in some cases, or the URL of the server 5 is stored in the memory of the optical disc drive 32, and, for example, is received from the optical disc drive 32 together with media information in some cases. Also, the multiple URLs of the servers 5 are obtained corresponding to multiple media IDs in some cases.

Subsequently, the recording setting information obtaining and setting unit 3111 transmits a recording setting information request signal (hereafter, referred to as a strategy request signal) including the drive ID obtained in step S11 to the URL of the server 5 obtained in step S25 through the network 1 (step S27). In the case of obtaining strategy data from the multiple servers 5, steps S27 through S33 are executed a plurality of times, which plurality of times may be equivalent to the number of servers 5. Note that when a membership system or the like is employed for use of the server 5, step S27 is executed after execution of processing for login.

When receiving the strategy request signal including the drive ID from the PC 3 (step S29), the server 5 searches the strategy data storing unit 51 using the received drive ID and may read out substantially all of the strategy data corresponding to the drive ID thereof and transmits this to the PC 3 which is the request source (step S31). The recording setting information obtaining and setting unit 3111 of the data writing unit 311 in the PC 3 receives the strategy data corresponding to the drive ID from the server 5, and temporarily stores this, for example, in a hard disk drive or the like (step S33). The processing proceeds to the processing shown in FIG. 8 through a terminal B.

Now, description will proceed to the processing shown in FIG. 8, where the recording setting information obtaining and setting unit 3111 outputs a strategy setting command including the received strategy data to the optical disc drive 32 (step S35). The optical disc drive 32 receives the strategy setting command including the strategy data (step S37), and records the strategy data in the recording setting information storing unit 321, for example by overwriting (step S39). Note that an arrangement may be made wherein the prior (e.g., default) strategy data is left as is, and the received strategy data is added. Also, the recording setting information obtaining and setting unit 3111 outputs from the strategy data of the media ID obtained in step S19 to the optical disc drive 32, whereby the processing in step S39 and the processing in step S41 and thereafter can be executed in parallel, and accordingly, data recording can be completed early.

Subsequently, the optical disc drive 32 reads out the strategy data corresponding to the media ID read out in step S17 from the recording setting information storing unit 321, and sets this as strategy data to be used this time (step S41). Subsequently, the optical disc drive 32 may execute regular test recording, e.g., an optimum recording power control method (hereafter, referred to as OPC) to determine the optimum recording power (step S43). With regard to this processing, a known technique can be employed, so detailed description thereof will be omitted. Subsequently, the optical disc drive 32 sets the recording power, which may be the optimum recording power determined in step S43, to be used this time (step S45). Thus, preparation for executing data recording has been completed.

Thus, the optical disc drive 32 informs the data writing unit 311 of the PC main unit 31, of the setting completion of recording power (step 47). When receiving the setting completion notice of recording power from the optical disc drive 32 (step S49), the data writing unit 311 outputs recording data to the optical disc drive 32 (step S51). The optical disc drive 32 receives the recording data from the PC main unit 31, and performs data recording in accordance with the settings performed above (step S53).

On the other hand, the processing in the case of no strategy data having been obtained from the server 5, i.e., the processing at the terminal A and thereafter will be described with reference to FIG. 9. In this case, the data writing unit 311 instructs the optical disc drive 32 to perform recording preparation (step S55). When receiving the recording preparation instructions from the PC main unit 31 (step S57), the optical disc drive 32 reads out the strategy data corresponding to the media ID read out in step S17 from the recording setting information storing unit 321, and sets this as strategy data to be used this time (step S59). Subsequently, the optical disc drive 32 performs regular test recording, e.g., OPC to determine the optimum recording power (step S61). With regard to this processing, a known technique can be employed, so detailed description thereof will be omitted. Subsequently, the optical disc drive 32 sets the optimum recording power determined in step S61 as recording power to be used this time (step S63). Thus, preparation for performing data recording has been completed.

Thus, the optical disc drive 32 informs the data writing unit 311 of the PC main unit 31, of the setting completion of recording power (step S65). When receiving the setting completion notice of recording power from the optical disc drive 32 (step S67), the data writing unit 311 outputs recording data to the optical disc drive 32 (step S69). The optical disc drive 32 receives the recording data from the PC main unit 31, and performs data recording in accordance with the settings performed above (step S71).

In the case of receiving substantially all of the strategy data corresponding to the drive ID, such processing is performed, whereby, even after the user purchased the PC 3 or the optical disc drive 32, strategy data to be required from now on at the time of connecting to the server 5 can be obtained and set. In other words, in a case wherein an optical disc sold after purchase of the PC 3 or relevant optical disc drive 32 is subjected to data recording, without connecting to the server 5 each time data recording is performed, suitable strategy data can be obtained beforehand, so data recording can be performed using this, and accordingly, the user can subject an optical disc such as CD-R, DVD-R, or the like to data recording appropriately.

Note that an example has been described above wherein strategy data is obtained from the server 5. This strategy data includes power control information in some cases. This power control information may include OPC conditions of OPC executed in step S43 in some cases. The OPC conditions may include (1) setting values regarding recording power Pw at the time of mark formation which is main power shown in FIGS. 3 and 4 at the time of test recording, bias power Pbw, power Ps at the time of space formation, cooling pulse power Pc, and intermediate pulse power Pm, or (2) optimum power determination reference value in some cases.

In the case of (1), the main power (Pw) conditions include predetermined modification conditions as to multiple setting values, or one reference set value and the reference set value. Also, with regard to the conditions other than the main power, for example, predetermined coefficients (εPbw, εPs, εPc, εPm, e.g., Pbw=Pw×εPbw) as to the main power (Pw) are included. Note that in the case of being calculated in a form such as Pbw=Pw×εPbw+α, there is a case wherein an offset value α is included in some cases.

In the case of (2), with regard to each media ID, a value serving as a target (β value in the case of DVD, a target value serving as an asymmetry value in the case of Blu-ray), or extrapolation condition parameters (κ, Pind, Mind, ρ, etc.) from a modulation factor curve as to the main power (Pw) is included.

Also, the power control information includes (1) a measurement value (β value, asymmetry value, voltage level value, etc.) or the adjustment amount of recording power (e.g., a recording power adjustment amount table or derivation expression) corresponding to the amount of difference between the measurement value and a target value, according to recording rate conditions, (2) a recording power set value according to recording rate conditions (a setting table or derivation expression), (3) an optimum recording power reference value according to recording rate conditions, and so forth, with a method for temporarily stopping recording operation to resume recording after recording power adjustment (hereafter, abbreviated as WOPC (Walking OPC)), or a method for performing recording power adjustment in parallel without stopping recording operation (hereafter, abbreviated as ROPC (Running OPC)).

### Second Embodiment

FIG. 10 illustrates a system overview according to a second embodiment of the present invention. The difference with the system overview according to the first embodiment shown in FIG. 1 is in that an optical disc use history management file 312 is installed in the PC main unit 31. This optical disc use history management file 312 stores data, for example, such as shown in FIG. 11. With the example shown in FIG. 11, use counts, last use dates, and rankings are registered for each media ID which has been used. The rankings represent, for example, rankings with many use counts, or rankings with closer to the current date of the last use dates, or the like. The data writing unit 311 manages, for example, such an optical disc use history management file 312, and performs processing such as shown below. Note that, in FIG. 10, with regard to the components other than the optical disc use history management file 312, some have functions different from those in the first embodiment, but the same reference numerals will be employed here.

First, for example, in response to the instructions of the user of the PC 3, the data writing unit 311 is activated (step S81). Also, the user inserts an optical disc to be subjected to data recording this time into the optical disc drive 32, whereby the optical disc drive 32 sets the optical disc to a spindle motor and so forth (step S83).

Subsequently, the data writing unit 311 of the PC main unit 31 outputs a drive ID request signal to the optical disc drive 32 (step S85). On the other hand, the optical disc drive 32 receives the drive ID request signal from the data writing unit 311 (step S87), and, for example, reads out the drive ID stored in the memory of the optical disc drive 32 to output this to the data writing unit 311 (step S89). The data writing unit 311 receives the drive ID from the optical disc drive 32, and, for example, stores this in the main memory (step S91). Note that, in a case wherein there has already been drive data obtained, such as by an OS (Operating System) or the like as the configuration data of the PC 3, the data writing unit 311 may employ the data instead of executing steps S85 through S91.

Further, the data writing unit 311 outputs a media information acquisition request signal to the optical disc drive 32 (step S93). The optical disc drive 32 receives the media information acquisition request signal (step S95), reads out media information such as a media ID and so forth from the optical disc set in step S83, and outputs this to the data writing unit 311 (step S97). The data writing unit 311 receives the media information from the optical disc drive 32, and, for example, stores this in the main memory (step S99). The media information sometimes includes dedicated codes representing that processing such as obtaining strategy data from the server 5 is carried out.

Also, the data writing unit 311 may prompt the user to input recording conditions and so forth (recording rate, instructions regarding whether to execute processing such as obtaining strategy data from the server 5 (including settings such as execution, non-execution, automatic execution, etc.), etc.), and accept input of the recording conditions and so forth from the user (step S101).

Subsequently, the data writing unit 311 determines whether to obtain strategy data from the server 5 (step S103). For example, in the case of being instructed by the user in step S101, in the case of dedicated codes such as described in step S99 being received, in the case of confirming that the PC 3 is connected to the network 1, or the like, determination is made that strategy data is obtained from the server 5. In other cases, the processing proceeds to the processing shown in FIG. 9 described in the first embodiment through a terminal A. Accordingly, description thereof will be omitted.

In the case of obtaining strategy data from the server 5, the recording setting information obtaining and setting unit 3111 of the data writing unit 311 reads out a registered media ID from the optical disc use history management file 312 (step S105). In this step, all of the registered media IDs may be read out, or, for example, the media IDs up to the tenth place may be read out. Note that when accessing the server 5 for the first time, no media ID is registered in the optical disc use history management file 312, so consequently, there is no registered media ID. Subsequently, the URL of the server 5 which corresponds to the registered media ID and acquisition media ID, and holds strategy data is read out, for example, from the URL management file 313 (step S107). Note that the URL of the server 5 is managed by the PC main unit 31 in some cases, or the URL of the server 5 is stored in the memory of the optical disc drive 32, and, for example, is received from the optical disc drive 32 together with media information in some cases. Also, the multiple URLs of the servers 5 are obtained in some cases. The processing proceeds to the processing shown in FIG. 13 through a terminal C.

Now, description will proceed to the description of the processing shown in FIG. 13, where the recording setting information obtaining and setting unit 3111 transmits a strategy request signal including the drive ID obtained in step S91, acquisition media ID obtained in step S99, and registered media ID read out in step S105 to the URL of the server 5 obtained in step S107 through the network 1 (step S109). In the case of obtaining strategy data from the multiple servers 5, steps S109 through S115 are executed a plurality of times, which plurality of times may be equivalent to the number of servers 5. At that time, a strategy request signal is generated so as to be divided into the corresponding media ID for each server 5. Note that when a membership system or the like is employed for use of the server 5, step S109 is executed after execution of processing for login.

When receiving the strategy request signal including the drive ID, acquisition media ID, and registered media ID from the PC 3 (step S111), the server 5 searches the strategy data storing unit 51 using a combination between the received drive ID and each media ID to read out the strategy data corresponding to the drive ID and media ID, and transmits this to the PC 3 which is the request source (step S113). The recording setting information obtaining and setting unit 3111 of the data writing unit 311 in the PC main unit 31 receives the strategy data corresponding to the drive ID and media ID from the server 5, and temporarily stores this, for example, in a hard disk drive or the like (step S115).

Subsequently, the recording setting information obtaining and setting unit 3111 outputs a strategy setting command including the received strategy data to the optical disc drive 32 (step S117). The optical disc drive 32 receives the strategy setting command including the strategy data (step S119), and records the strategy data in the recording setting information storing unit 321, for example by overwriting (step S121). Note that an arrangement may be made wherein the prior (e.g., default) strategy data is left as is, and the received strategy data is added.

On the other hand, the recording setting information obtaining and setting unit 3111 of the data writing unit 311 in the PC main unit 31 updates the optical disc use history management file 312 (step S131). Specifically, the recording setting information obtaining and setting unit 3111 determines whether or not the media ID obtained in step S99 has been registered in the optical disc use history management file 312, and in the case of the media ID having been registered, increments the use count by one, and updates the last use date to today. Further, when sorting the use counts in descending order, and the rankings are changed, the recording setting information obtaining and setting unit 3111 updates the column of rankings. On the other hand, in a case wherein the media ID obtained in step S99 has not been registered, the recording setting information obtaining and setting unit 3111 registers the media ID, sets the use counts to 1, and registers the last use date to today. Further, the recording setting information obtaining and setting unit 3111 sets the ranking thereof to the lowest ranking.

Also, the optical disc drive 32 reads out the strategy data corresponding to the media ID read out in step S97 from the recording setting information storing unit 321, and sets this as the strategy data to be used this time (step S123). Subsequently, the optical disc drive 32 may perform regular test recording, e.g., OPC to determine the optimum recording power (step S125). With regard to this processing, a known technique can be employed, so detailed description thereof will be omitted. Subsequently, the optical disc drive 32 sets the recording power, which may be the optimum recording power determined in step S125, to be used this time (step S127). Thus, preparation for performing data recording has been completed.

Thus, the optical disc drive 32 informs the data writing unit 311 of the PC main unit 31, of the setting completion of recording power (step S129). When receiving the setting completion notice of recording power from the optical disc drive 32 (step S133), the data writing unit 311 outputs the recording data to the optical disc drive 32 (step S135). The optical disc drive 32 receives the recording data from the PC main unit 31, and performs data recording in accordance with the settings performed above (step S137).

Such processing is performed, whereby the amount of strategy data to be downloaded can be reduced as compared to the first embodiment if substantially all of the strategy data is downloaded. In other words, communication load is reduced, whereby data recording can be started early. Also, even in the case of the PC 3 which cannot be connected to the network 1 all the time, with regard to an optical disc of which the frequency of use is a predetermined level or more, the newest strategy data can be obtained at timing wherein the server 5 can be accessed through the network 1, thereby subjecting an optical disc to suitable data recording using suitable strategy data with a high ratio.

Note that, with the present embodiment as well, as described with the first embodiment, the power control information is obtained from the server 5 in some cases.

### Third Embodiment

The system overview according to the present embodiment is generally the same as that in the first embodiment. Accordingly, the operation content differs from that in the first embodiment, but the reference numerals shown in FIG. 1 are employed as is. Description will be made below regarding the processing content according to the present embodiment, shown in FIG. 14.

First, for example, in response to the instructions of the user of the PC 3, the data writing unit 311 is activated (step S141). Also, the user inserts an optical disc to be subjected to data recording this time into the optical disc drive 32, whereby the optical disc drive 32 sets the optical disc to a spindle motor and so forth (step S143).

Subsequently, the data writing unit 311 of the PC main unit 31 outputs a drive ID request signal to the optical disc drive 32 (step S145). On the other hand, the optical disc drive 32 receives the drive ID request signal from the data writing unit 311 (step S147), and, for example, reads out the drive ID stored in the memory of the optical disc drive 32 to output this to the data writing unit 311 (step S149). The data writing unit 311 receives the drive ID from the optical disc drive 32, and, for example, stores this in the main memory (step S151). Note that, in a case wherein there has already been drive data obtained, such as by an OS (Operating System) or the like as the configuration data of the PC 3, the data writing unit 311 may employ the data instead of executing steps S145 through S151.

Further, the data writing unit 311 outputs a media information acquisition request signal to the optical disc drive 32 (step S153). The optical disc drive 32 receives the media information acquisition request signal (step S155), reads out media information such as a media ID and so forth from the optical disc set in step S143, and outputs this to the data writing unit 311 (step S157). The data writing unit 311 receives the media information from the optical disc drive 32, and, for example, stores this in the main memory (step S159). The media information sometimes includes dedicated codes representing that processing such as obtaining strategy data from the server 5 is carried out.

Also, the data writing unit 311 may prompt the user to input recording conditions and so forth (recording rate, instructions regarding whether to execute processing such as obtaining strategy data from the server 5 (including settings such as execution, non-execution, automatic execution, etc.), etc.), and accept input of the recording conditions and so forth from the user (step S161).

Subsequently, the data writing unit 311 determines whether to obtain strategy data from the server 5 (step S163). For example, in the case of being instructed by the user in step S161, in the case of dedicated codes such as described in step S159 being received, in the case of confirming that the PC 3 is connected to the network 1, or the like, determination is made that strategy data is obtained from the server 5. In other cases, the processing proceeds to the processing shown in FIG. 9 described in the first embodiment through a terminal A. Accordingly, description thereof will be omitted.

In the case of obtaining strategy data from the server 5, the recording setting information obtaining and setting unit 3111 of the data writing unit 311 reads out the URL of the server S holding strategy data, for example, from the URL management file 313, in accordance with the acquisition media ID (step S165). Note that the URL of the server 5 is managed by the PC main unit 31 in some cases, or the URL of the server 5 is stored in the memory of the optical disc drive 32, and, for example, is received from the optical disc drive 32 together with media information in some cases.

Subsequently, the recording setting information obtaining and setting unit 3111 transmits a strategy request signal including the drive ID obtained in step S151 and the acquisition media ID obtained in step S159 to the URL of the server 5 obtained in step S165 through the network 1 (step S167). In the case of multiple URLs being extracted, the recording setting information obtaining and setting unit 3111 transmits a strategy request signal to each of the URLs. Note that when a membership system or the like is employed for use of the server 5, step S167 is executed after execution of processing for login.

When receiving the strategy request signal including the drive ID and acquisition media ID from the PC 3 (step S169), the server 5 searches the strategy data storing unit 51 using a combination between the received drive ID and acquisition media ID to read out the strategy data corresponding to the drive ID and acquisition media ID thereof, and transmits this to the PC 3 which is the request source (step S171). The recording setting information obtaining and setting unit 3111 of the data writing unit 311 in the PC main unit 31 receives the strategy data corresponding to the drive ID and acquisition media ID from the server 5, and temporarily stores this, for example, in a hard disk drive or the like (step S173). The processing proceeds to the processing shown in FIG. 15 through a terminal D.

Now, description will proceed to the processing shown in FIG. 15, where the recording setting information obtaining and setting unit 3111 outputs a strategy setting command including the received strategy data to the optical disc drive 32 (step S175). The optical disc drive 32 receives the strategy setting command including the strategy data (step S177), and records the strategy data in the recording setting information storing unit 321, such as by overwriting (step S179). Note that an arrangement may be made wherein the prior (e.g., default) strategy data is left as is, and the received strategy data is added.

Also, the optical disc drive 32 reads out the strategy data corresponding to the media ID read out in step S157 from the recording setting information storing unit 321, and sets this as strategy data to be used this time (step S181). Subsequently, the optical disc drive 32 may execute regular test recording, e.g., OPC to determine the optimum recording power (step S183). With regard to this processing, a known technique can be employed, so detailed description thereof will be omitted. Subsequently, the optical disc drive 32 sets the recording power, which may be the optimum recording power determined in step S183, to be used this time (step S185). Thus, preparation for executing data recording has been completed.

Thus, the optical disc drive 32 informs the data writing unit 311 of the PC main unit 31, of the setting completion of recording power (step S187). When receiving the setting completion notice of recording power from the optical disc drive 32 (step S189), the data writing unit 311 outputs recording data to the optical disc drive 32 (step S191). The optical disc drive 32 receives the recording data from the PC main unit 31, and performs data recording in accordance with the settings performed above (step S193).

Such processing is performed, whereby the newest strategy data necessary for an optical disc to be used this time can be obtained, and accordingly, data recording can be performed appropriately. Note that the amount of data to be downloaded from the server 5 is reduced as compared to that in the first and second embodiments, whereby data recording can be started early. Also, with the present embodiment, strategy data regarding all of the recording rates can be obtained, whereby, for example, even a case wherein writing cannot be performed at the recording rate specified by the user can be handled.

Note that, as with the first and second embodiments, the power control information is obtained from the server 5 in some cases.

### Fourth Embodiment

The system overview according to the present embodiment is generally the same as that in the first embodiment. Accordingly, the operation content differs from that in the first embodiment, but the reference numerals shown in FIG. 1 are employed as is. Description will be made below regarding the processing content according to the present embodiment, shown in FIG. 16.

First, for example, in response to the instructions of the user of the PC 3, the data writing unit 311 is activated (step S201). Also, the user inserts an optical disc to be subjected to data recording this time into the optical disc drive 32, whereby the optical disc drive 32 sets the optical disc to a spindle motor and so forth (step S203).

Subsequently, the data writing unit 311 of the PC main unit 31 outputs a drive ID request signal to the optical disc drive 32 (step S205). On the other hand, the optical disc drive 32 receives the drive ID request signal from the data writing unit 311 (step S207), and, for example, reads out the drive ID stored in the memory of the optical disc drive 32 to output this to the data writing unit 311 (step S209). The data writing unit 311 receives the drive ID from the optical disc drive 32, and, for example, stores this in the main memory (step S211). Note that, in a case wherein there has already been drive data obtained, such as by an OS (Operating System) or the like as the configuration data of the PC 3, the data writing unit 311 may employ the data instead of executing steps S205 through S211.

Further, the data writing unit 311 outputs a media information acquisition request signal to the optical disc drive 32 (step S213). The optical disc drive 32 receives the media information acquisition request signal (step S215), reads out media information such as a media ID and so forth from the optical disc set in step S203, and outputs this to the data writing unit 311 (step S217). The data writing unit 311 receives the media information from the optical disc drive 32, and, for example, stores this in the main memory (step S219). The media information sometimes includes dedicated codes representing that processing such as obtaining strategy data from the server 5 is carried out.

Also, the data writing unit 311 may prompt the user to input recording conditions and so forth (recording rate, instructions regarding whether to execute processing such as obtaining strategy data from the server 5 (including settings such as execution, non-execution, automatic execution, etc.), etc.), and accept input of the recording conditions and so forth from the user (step S221).

Subsequently, the data writing unit 311 determines whether to obtain strategy data from the server 5 (step S223). For example, in the case of being instructed by the user in step S221, in the case of dedicated codes such as described in step S219 being received, in the case of confirming that the PC 3 is connected to the network 1, or the like, determination is made that strategy data is obtained from the server 5. In other cases, the processing proceeds to the processing shown in FIG. 9 described in the first embodiment through a terminal A. Accordingly, description thereof will be omitted.

In the case of obtaining strategy data from the server 5, the recording setting information obtaining and setting unit 3111 of the data writing unit 311 reads out the URL of the server 5 holding strategy data, for example, from the URL management file 313, corresponding to the acquisition media ID (step S225). Note that the URL of the server 5 is managed by the PC main unit 31 in some cases, or the URL of the server 5 is stored in the memory of the optical disc drive 32, and, for example, is received from the optical disc drive 32 together with media information in some cases.

Subsequently, the recording setting information obtaining and setting unit 3111 transmits a strategy request signal including the drive ID obtained in step S211, the acquisition media ID obtained in step S219, and the recording rate, which may have been obtained in step S221, to the URL (server 5) obtained in step S225 through the network 1 (step S227). Note that when a membership system or the like is employed for use of the server 5, step S227 is executed after execution of processing for login.

When receiving the strategy request signal including the drive ID and acquisition media ID and recording rate from the PC 3 (step S229), the server 5 searches the strategy data storing unit 51 using a combination between the received drive ID and acquisition media ID and recording rate to read out the strategy data corresponding to the drive ID and acquisition media ID thereof, and transmits this to the PC main unit 31 which is the request source (step S231). The recording setting information obtaining and setting unit 3111 of the data writing unit 311 in the PC 3 receives the strategy data corresponding to the drive ID and acquisition media ID from the server 5, and temporarily stores this, for example, in a hard disk drive or the like (step S233). The processing proceeds to the processing shown in FIG. 17 through a terminal E.

Now, description will proceed to the processing shown in FIG. 17, where the recording setting information obtaining and setting unit 3111 outputs a strategy setting command including the received strategy data to the optical disc drive 32 (step S235). The optical disc drive 32 receives the strategy setting command including the strategy data (step S237), and records the strategy data in the recording setting information storing unit 321, such as by overwriting (step S239). Note that an arrangement may be made wherein the prior (e.g., default) strategy data is left as is, and the received strategy data is added.

Also, the optical disc drive 32 reads out the strategy data corresponding to the media ID read out in step S217 from the recording setting information storing unit 321, and sets this as strategy data to be used this time (step S241). Subsequently, the optical disc drive 32 may execute regular test recording, e.g., OPC to determine the optimum recording power (step S243). With regard to this processing, a known technique can be employed, so detailed description thereof will be omitted. Subsequently, the optical disc drive 32 sets the recording power, which may be the optimum recording power determined in step S243, to be used this time (step S245). Thus, preparation for executing data recording has been completed.

Thus, the optical disc drive 32 informs the data writing unit 311 of the PC main unit 31, of the setting completion of recording power (step S247). When receiving the setting completion notice of recording power from the optical disc drive 32 (step S249), the data writing unit 311 outputs recording data to the optical disc drive 32 (step S251). The optical disc drive 32 receives the recording data from the PC main unit 31, and performs data recording in accordance with the settings performed above (step S253).

Such processing is performed, whereby the minimal data necessary for data recording to be performed this time can be obtained, and the amount of data to be downloaded from the server 5 is reduced as compared to that in the first through third embodiments, whereby data recording can be started early.

Note that, as with the first through third embodiments, the power control information is obtained from the server 5 in some cases.

### Fifth Embodiment

With the fifth embodiment, as shown in FIG. 18, there are implemented an administration server 7 serving as a first server, and an administration table storing unit 71 which is managed by the administration server 7, and stores an administration table including data relating to the updated state of strategy data. Such an administration server 7 is managed, for example, by an optical drive maker or a data write program supplier or the like. Alternatively, the administration server 7 may be managed by independent businesses. Note that description will be made assuming that the server 5 shown in FIG. 1 is a second server, and is hereafter taken as an access server to distinguish this from the administration server 7. Also, an access history management file 314 which stores access histories as to the access server 5 is provided in the PC main unit 31. Further, let us say that the URL of the administration server 7 has been registered in the URL management file 313. Note that with the present embodiment, the operation content differs from that in the first embodiment, but the same reference numerals are denoted to the same named functions.

FIG. 19 illustrates an example of the administration table stored in the administration table storing unit 71. With the example shown in FIG. 19, an arrangement is made wherein, for each media ID, the URL of the access server 5, and the reset date of the strategy data of the media ID are registered.

Also, for example, data such as shown in FIG. 20 is registered in the access history management file 314. With the example shown in FIG. 20, an arrangement is made wherein access date and time is accumulated wherein the PC main unit 31 accesses the administration server 7.

Next, the processing content of the system shown in FIG. 18 will be described with reference to FIGS. 21 through 23. First, for example, in response to the instructions of the user of the PC 3, the data writing unit 311 is activated (step S261). Also, the user inserts an optical disc to be subjected to data recording this time into the optical disc drive 32, whereby the optical disc drive 32 sets the optical disc to a spindle motor and so forth (step S263).

Subsequently, the data writing unit 311 of the PC main unit 31 outputs a drive ID request signal to the optical disc drive 32 (step S265). On the other hand, the optical disc drive 32 receives the drive ID request signal from the data writing unit 311 (step S267), and, for example, reads out the drive ID stored in the memory of the optical disc drive 32 to output this to the data writing unit 311 (step S269). The data writing unit 311 receives the drive ID from the optical disc drive 32, and, for example, stores this in the main memory (step S271). Note that, in a case wherein there has already been drive data obtained, for example by an OS (Operating System) or the like as the configuration data of the PC 3, the data writing unit 311 may employ the data instead of executing steps S265 through S271.

Further, the data writing unit 311 outputs a media information acquisition request signal to the optical disc drive 32 (step S273). The optical disc drive 32 receives the media information acquisition request signal (step S275), reads out media information such as a media ID and so forth from the optical disc set in step S263, and outputs this to the data writing unit 311 (step S277). The data writing unit 311 receives the media information from the optical disc drive 32, and, for example, stores this in the main memory (step S279). The media information sometimes includes dedicated codes representing that processing such as obtaining strategy data from the access server 5 is carried out.

Also, the data writing unit 311 may prompt the user to input recording conditions and so forth (recording rate, instructions regarding whether to execute processing such as obtaining strategy data from the access server 5 (including settings such as execution, non-execution, automatic execution, etc.), and so forth), and accept input of the recording conditions and so forth from the user (step S281).

Subsequently, the data writing unit 311 determines whether to obtain strategy data from the access server 5 (step S283). For example, in the case of being instructed by the user in step S281, in the case of dedicated codes such as described in step S279 being received, in the case of confirming that the PC 3 is connected to the network 1, or the like, determination is made that strategy data is obtained from the access server 5. In other cases, the processing proceeds to the processing shown in FIG. 9 described in the first embodiment through a terminal A. Accordingly, description thereof will be omitted.

The processing in the case of obtaining strategy data from the access server 5 will be as follows. First, the recording setting information obtaining and setting unit 3111 reads out the URL of the administration server 7, for example, from the URL management file 313 (step S285). Note that the URL of the administration server 7 is managed by the PC main unit 31 in some cases, or the URL of the administration server 7 is stored in the memory of the optical disc drive 32, and, for example, is received from the optical disc drive 32 together with media information in some cases.

Subsequently, the recording setting information obtaining and setting unit 3111 reads out the data of the last access date and time from the access history management file 314, and transmits an update setting item request signal including the last access date and time to the URL of the administration server 7 obtained in step S285 (step S287). Note that when a membership system or the like is employed for use of the administration server 7, step S287 is executed after execution of processing for login.

When receiving the update setting item request signal including the last access date and time from the PC 3 (step S289), the administration server 7 searches the administration table storing unit 71 using the last access date and time, extracts the media ID of a record in which the reset date of the last access date and time and thereafter is registered, and the URL of the corresponding access server 5, and replies these to the PC 3 which is the request source (step S291). The recording setting information obtaining and setting unit 3111 of the data writing unit 311 in the PC main unit 31 receives the media ID and URL of which the strategy data has been updated from the administration server 7, and stores, for example, in the main memory (step S293). The processing proceeds to the processing shown in FIG. 22 through a terminal F. Note that a combination between a media ID and URL is not received at all in some cases. In this case, the processing proceeds to the processing shown in FIG. 9, though not shown in the drawing.

Now, description will proceed to the description of the processing shown in FIG. 22, where the recording setting information obtaining and setting unit 3111 transmits a strategy request signal including the drive ID obtained in step S271, and media ID (acquisition media ID) received in step S293 to the URL of the access server 5 received in step S293 (step S294). In the case of receiving multiple combinations between a media ID and URL, strategy request signals thereof are grouped into a single strategy request signal for each destination URL. For example, with the example shown in FIG. 19, when ID_a and ID_b are informed from the administration server 7, the access server 5 URLs thereof is the same, so the strategy request signals thereof are grouped into a single strategy request signal. However, the same strategy request signal may be transmitted multiple times as an individual strategy request signal.

When receiving the strategy request signal including the drive ID and acquisition media ID from the PC 3 (step S295), the access server 5 searches the strategy data storing unit 51 using a combination between the received drive ID and acquisition media ID to read out the strategy data corresponding to the drive ID and acquisition media ID, and transmits this to the PC 3 which is the request source (step S297). The recording setting information obtaining and setting unit 3111 of the data writing unit 311 in the PC main unit 31 receives the strategy data corresponding to the drive ID and acquisition media ID from the access server 5, and temporarily stores this, for example, in a hard disk drive or the like (step S299).

Subsequently, the recording setting information obtaining and setting unit 3111 outputs a strategy setting command including the received strategy data to the optical disc drive 32 (step S301). The optical disc drive 32 receives the strategy setting command including the strategy data (step S303), and records the strategy data in the recording setting information storing unit 321, such as by overwriting (step S305). Note that an arrangement may be made wherein the prior (e.g., default) strategy data is left as is, and the received strategy data is added.

Also, the optical disc drive 32 reads out the strategy data corresponding to the media ID read out in step S277 from the recording setting information storing unit 321, and sets this as the strategy data to be used this time (step S307). Subsequently, the optical disc drive 32 may perform regular test recording, e.g., OPC to determine the optimum recording power (step S309). With regard to this processing, a known technique can be employed, so detailed description thereof will be omitted. Subsequently, the optical disc drive 32 sets the recording power, which may be the optimum recording power determined in step S309, to be used this time (step S311). Thus, preparation for performing data recording has been completed.

Thus, the optical disc drive 32 informs the data writing unit 311 of the PC main unit 31, of the setting completion of recording power (step S313). When receiving the setting completion notice of recording power from the optical disc drive 32 (step S315), the data writing unit 311 outputs the recording data to the optical disc drive 32 (step S317). The optical disc drive 32 receives the recording data from the PC main unit 31, and performs data recording in accordance with the settings performed above (step S319).

According to such processing, only the updated strategy data is obtained from the access server 5 as necessary, whereby the amount of data to be downloaded from the access server 5 can be reduced, and accordingly, data recording can be started early.

In order to further reduce the amount of data to be downloaded from the access server 5, for example, as shown in FIG. 23, with the data stored in the administration table storing unit 71, reset dates are managed not for each media ID but for each parameter of which the strategy data has been updated, or simply for each parameter. Subsequently, the updated parameter is included in a strategy request, thereby downloading only the data regarding the updated parameter.

The present embodiment can be modified in addition to the above modification. For example, though the data updated on the last accessed date-and-time and thereafter has been extracted at the administration server 7, but for example, an arrangement may be made wherein the data stored in the administration table storing unit 71 is downloaded from the administration server 7, and the data updated on the last accessed date-and-time and thereafter is extracted at the data writing unit 311 of the PC main unit 31.

Also, an arrangement may be made wherein data such as shown in FIG. 6 is held additionally at the URL management file 313, and the administration server 7 informs only the media ID of which the strategy data has been updated, thereby determining the URL at the PC main unit 31.

Further, an arrangement may be made wherein the media ID received in step S279 is included in an update condition data request, whereby the data to be extracted at the administration server 7 can be restricted to the media ID. Similarly, an arrangement may be made wherein the present embodiment is combined with the second through fourth embodiments.

While embodiments of the present invention have been described so far, the present invention is not restricted to these. For example, the function block diagrams shown in FIGS. 1, 10, and 18 are illustrated for convenience of explanation, and accordingly, these do not necessarily correspond to an actual program module configuration in some cases.

Also, if the same results can be obtained regarding a processing flow, the processing order or the like can be modified. Further, though the examples have been shown regarding the PC, a recording device which has an optical disc drive built-in, and is connected to a network is employed instead of the PC in some cases.

Note that the PC 3, administration server 7, and server 5 are, for example, a computer device, and with the computer device, as shown in FIG. 24, memory 2501 (storage unit), CPU 2503 (processing unit), hard disk drive (HDD) 2505, display control unit 2507 connected to a display device 2509, drive device 2513 for a removable disk 2511, input device 2515, and communication control unit 2517 for connecting to a network are connected through a bus 2519. Application programs including an OS (Operating System), and web browser are stored in the HDD 2505, and are read out from the HDD 2505 to the memory 2501 at the time of being executed by the CPU 2503. The CPU 2503 controls the display control unit 2507, communication control unit 2517, and drive device 2513 to perform necessary operation as necessary. Also, the data in the middle of processing is stored in the memory 2501, and is stored in the HDD 2505 if necessary. With such a computer, the above-mentioned hardware such as the CPU 2503, memory 2501, and so forth, an OS (Operating System), and the necessary application programs can be organically collaborated, thereby realizing various types of functions, such as described above.

The structure and the operation of the present invention are not limited to the above descriptions. Various modifications may be made without departing from the spirit and scope of the present invention. While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A method for obtaining and setting recording setting information, comprising:
obtaining device identification information of an optical disc recording/playback device;
transmitting a recording setting information request signal comprising at least said device identification information to a server connected through a network;
receiving recording setting information corresponding to at least said device identification information transmitted from said server based on said recording setting information request signal; and
storing said received recording setting information in memory within the optical disc recording/playback device.

2. The method for obtaining and setting recording setting information according to claim 1, wherein said received recording setting information corresponds to substantially all recording setting information corresponding to said optical disc recording/playback device.

3. The method for obtaining and setting recording setting information according to claim 1, further comprising:
obtaining a media ID read out from an optical disc set in said optical disc recording/playback device as an acquisition media ID; and
obtaining at least one media ID as a registered media ID from a media ID administration unit storing media IDs of optical discs having a type subjected to data recording at said optical disc recording/playback device in the past;
wherein said recording setting information request signal further comprises
said acquisition media ID, and
said registered media ID;
and wherein said recording setting information received corresponds to the media IDs included in said acquisition media ID and said registered media ID, and said device identification information.

4. The method for obtaining and setting recording setting information according to claim 1, further comprising:
obtaining a media ID read out from an optical disc set in said optical disc recording/playback device as an acquisition media ID;
wherein said recording setting information request signal further includes said acquisition media ID;
and wherein said recording setting information received corresponds to said acquisition media ID and said device identification information.

5. The method for obtaining and setting recording setting information according to claim 1, further comprising:
obtaining a media ID read out from an optical disc set in said optical disc recording/playback device as an acquisition media ID; and
obtaining recording rate information of data recording carried out at said optical disc recording/playback device;
wherein said recording setting information request signal further comprises
said acquisition media ID, and
said recording rate information;
and wherein said recording setting information received corresponds to said acquisition media ID, said recording rate information, and said device identification information.

6. The method for obtaining and setting recording setting information according to claim 4, further comprising:
obtaining an address of a server serving as a transmission destination from an address administration unit holding the transmission destination server address of said recording setting information request signal for each media ID;
wherein said transmitting comprises transmitting said recording setting information request signal to said address obtained in said obtained address.

7. The method for obtaining and setting recording setting information according to claim 3, wherein said obtaining said registered media ID comprises:
extracting a media ID of an optical disc of which a frequency of use is a predetermined level or more from said media ID administration unit as said registered media ID.

8. A method for obtaining and setting recording setting information, comprising:
obtaining a device identification information of an optical disc recording/playback device;
transmitting an update setting item request signal including at least data representing a last access date and time to a first server;
receiving recording setting information items updated at said last access date and time and thereafter, transmitted from said first server based on said update setting item request signal;
transmitting a recording setting information request signal comprising at least the received updated items of said recording setting information items and said device identification information to a second server;
receiving said recording setting information corresponding to said device identification information transmitted from said second server based on said recording setting information request signal; and
storing said received recording setting information in memory within the optical disc recording/playback device.

9. The method for obtaining and setting recording setting information according to claim 8, wherein said receiving said recording setting information items comprises receiving an address and data of said second server together with said recording setting information items.

10. The method for obtaining and setting recording setting information according to claim 7, wherein said recording setting information items are identified with at least one combination of a combination between a media ID, and media ID and strategy parameters, and a combination between a media ID, strategy parameter, and recording rate.

11. A computer readable medium storing executable instructions for causing a computer to execute the steps of:
obtaining device identification information of an optical disc recording/playback device;
transmitting a recording setting information request signal comprising at least said device identification information to a server connected through a network;
receiving recording setting information corresponding to at least said device identification information transmitted from said server based on said recording setting information request signal; and
storing said received recording setting information in memory within the optical disc recording/playback device.

12. The program according to claim 11, further storing executable instructions for causing said computer to further execute the steps of:
obtaining a media ID read out from an optical disc set in said optical disc recording/playback device as an acquisition media ID; and
obtaining at least one media ID as a registered media ID from a media ID administration unit storing media IDs of optical discs having a type subjected to data recording at said optical disc recording/playback device in the past;
wherein said recording setting information request signal further comprises
said acquisition media ID, and
said registered media ID;
and wherein said recording setting information received corresponds to the media IDs included in said acquisition media ID and said registered media ID, and said device identification information.

13. The program according to claim 11, further storing executable instructions for causing said computer to further execute the steps of:
obtaining a media ID read out from an optical disc set in said optical disc recording/playback device as an acquisition media ID;
wherein said recording setting information request signal further includes said acquisition media ID;
and wherein said recording setting information received corresponds to said acquisition media ID and said device identification information.

14. The program according to claim 11, further storing executable instructions for causing said computer to further execute the steps of:
obtaining a media ID read out from an optical disc set in said optical disc recording/playback device as an acquisition media ID; and
obtaining a recording rate information of data recording carried out at said optical disc recording/playback device;
wherein said recording setting information request signal further comprises
said acquisition media ID, and
said recording rate information;
and wherein said recording setting information received corresponds to said acquisition media ID, said recording rate information, and said device identification information.

15. The program according to claim 13, further storing executable instructions for causing said computer to further execute the step of:
obtaining an address of a server serving as a transmission destination from an address administration unit holding the transmission destination server address of said recording setting information request signal for each media ID;
wherein said transmitting comprises transmitting said recording setting information request signal to said obtained address.

16. The program according to claim 12, wherein said obtaining said registered media ID comprises:
extracting a media ID of an optical disc of which a frequency of use is a predetermined level or more from said media ID administration unit as said registered media ID.

17. A computer readable medium storing executable instructions for causing a computer to execute the steps of:
obtaining device identification information of an optical disc recording/playback device;
transmitting an update setting item request signal including at least data representing a last access date and time to a first server;
receiving recording setting information items updated at said last access date and time and thereafter, transmitted from said first server based on said update setting item request signal;
transmitting a recording setting information request signal comprising at least the received updated items of said recording setting information items and said device identification information to a second server;
receiving said recording setting information corresponding to said device identification information transmitted from said second server based on said recording setting information request signal; and
storing said received recording setting information in memory within the optical disc recording/playback device.

18. The program according to claim 17, wherein said receiving said recording setting information items comprises receiving an address and data of said second server are received together with said recording setting information items.

19. The program according to claim 18, wherein said recording setting information items are identified with at least one combination of a combination between a media ID, and media ID and strategy parameters, and a combination between a media ID, strategy parameter, and recording rate.

20. A data recording/playback device comprising:
an optical disc recording/playback device;
means for obtaining device identification information of said optical disc recording/playback device,
means for transmitting a recording setting information request signal comprising at least said device identification information to a server connected through a network,
means for receiving recording setting information corresponding to at least said device identification information transmitted from said server based on said recording setting information request signal, and
means for storing said recording setting information in memory within the optical disc recording/playback device, and
means for performing data recording using said recording setting information stored in said memory.

21. The data recording/playback device according to claim 20, further comprising:
means for obtaining a media ID read out from an optical disc set in said optical disc recording/playback device as an acquisition media ID;
a media ID administration unit configured to store a media ID of an optical disc having a type subjected to data recording at said optical disc recording/playback device in the past; and
registered media ID acquisition means for acquiring one or more media IDs from said media ID administration unit as a registered media ID;
wherein said recording setting information request signal further comprises said acquisition media ID and said registered media ID;
and wherein said recording setting information received corresponds the media IDs included in said acquisition media ID and said registered media ID and said device identification information.

22. The data recording/playback device according to claim 20, further comprising:
means for obtaining a media ID read out from an optical disc set in said optical disc recording/playback device as an acquisition media ID;
wherein said recording setting information request signal further includes said acquisition media ID;
and wherein said recording setting information received corresponds to said acquisition media ID and said device identification information.

23. The data recording/playback device according to claim 20, further comprising:
means for obtaining a media ID read out from an optical disc set in said optical disc recording/playback device as an acquisition media ID; and
means configured to obtain recording rate information of data recording carried out at said optical disc recording/playback device;
wherein said recording setting information request signal further comprises
said acquisition media ID, and
said recording rate information;
and wherein said recording setting information received corresponds to said acquisition media ID, said recording rate information, and said device identification information.

24. The data recording/playback device according to claim 22, further comprising:
an address administration unit configured to hold an address of a transmission destination server of said recording setting information request signal for each media ID; and
means for obtaining an address of a server serving as a transmission destination from said address administration unit;
wherein said transmission means comprises means for transmitting said recording setting information request signal to said address obtained.

25. The data recording/playback device according to claim 21, wherein said registered media ID acquisition means comprises means for extracting a media ID of an optical disc of which a frequency of use is a predetermined level or more from said media ID administration unit as said registered media ID.

26. A data recording/playback device comprising:
an optical disc recording/playback device;
means for obtaining device identification information of said optical disc recording/playback device,
means for transmitting an update setting item request signal including at least data representing a last access date and time to a first server,
first reception means for receiving recording setting information items updated at said last access date and time and thereafter, transmitted from said first server based on said update setting item request signal,
means for transmitting a recording setting information request signal comprising at least the updated items of said recording setting information items received at said first reception means, and said device identification information to a second server;
second reception means configured for receiving said recording setting information corresponding to said device identification information transmitted from said second server based on said recording setting information request signal; and
means for outputting said recording setting information received at said second reception means to said optical disc recording/playback device; and
means configured to store said recording setting information in memory within the optical disc recording/playback device.

27. The data recording/playback device according to claim 26, wherein said first reception means comprises means for receiving an address and data of said second server together with said recording setting information items.

28. The data recording/playback device according to claim 26, wherein said recording setting information items are identified with at least one combination of a combination between a media ID, and media ID and strategy parameters, and a combination between a media ID, strategy parameter, and recording rate.

29. A method of managing data write functions of an optical disk recording/playback device, comprising:
receiving a recording setting information request signal comprising at least device identification information of the optical disk recording/playback device; and
transmitting recording setting information corresponding to at least said received device identification information.

30. The method of managing data write functions of an optical disk recording/playback device according to claim 29, further comprising searching a strategy data storing unit storing recording setting information corresponding to at least said received device identification information, and wherein said transmitting comprises transmitting substantially all of the recording setting information that is stored in the data storing unit and that corresponds to at least said received device identification information.
